(19) United States
(12) Patent Application Publication
(10) Pub. No.: US 2008/0081634 A1
(43) Pub. Date: Apr. 3, 2008

(54) Method, device, system and software product for adaptive feedback rate with packet-based connection

(76) Inventors: Jorma Kaikkonen, Oulu (FI); Gilles Charbit, Farnborough (GB); Kari Rikkinen, Li (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/904,313

(22) Filed: Sep. 25, 2007

Related U.S. Application Data
(60) Provisional application No. 60/847,272, filed on Sep. 25, 2006.

(51) Int. Cl. H04Q 7/20

(52) U.S. Cl. 455/452.1

(57) ABSTRACT

A method, mobile device, network device, system, and software are devised for storing a received specification of one or more thresholds regarding when to provide uplink feedback. The mobile device receives a multimedia broadcast multicast service via high speed downlink packet access over a high speed physical downlink shared channel, and then determines whether to provide the uplink feedback about the packet access. This determination is based upon whether channel quality falls below one of the thresholds, or based upon whether indications about a need for retransmissions exceed one of the thresholds.

### CROSS REFERENCE TO RELATED APPLICATION

Priority is claimed to U.S. Provisional Application 60/847,272 filed 25 Sep. 2006.

### FIELD OF THE INVENTION

The present invention pertains to the field of telecommunications. More particularly, the present invention pertains to feedback in packet-based telecommunications.

### BACKGROUND OF THE INVENTION

Third generation (3G) systems use a method originally defined in the first release (Release '99) of the standards for mobile communication, which provided for transferring data packets to user equipments (UEs) that do not maintain a dedicated connection with a Node B. A Node B is also known as a radio base station (RBS), or base transceiver station (BTS).

The Node B uses a secondary common control physical channel (S-CCPCH) that carries a forward access channel (FACH) coming from a radio network controller (RNC). The RNC incorporates a user identification ID into the FACH data packets. All users that are in the CELL_FACH state listen to the S-CCPCH, decode the FACH data packets and check the user ID; and, if they do not find their own ID, the message with the data packets is dropped.

A further development of the wideband code division multiple access (WCDMA) and/or universal mobile telecommunications system (UMTS) communication system defined by the 3GPP organization is the definition of the system known as high speed downlink packet access (HSDPA). HSDPA operates as a time-shared communications channel which provides the potential for high peak data rates as well as the possibility for having a high spectral efficiency.

3GPP HSDPA standards (e.g. 3GPP Release 5) have defined a high speed downlink shared channel (HS-DSCH), which is a downlink transport channel shared by several user equipments. The HS-DSCH is associated with one downlink dedicated physical channel (DPCH) per active user, and one or several high speed shared control channels (HS-SCCH). The HS-DSCH can be transmitted over the entire cell or over only part of the cell using for example beam-forming antennas.

HSDPA improves system capacity and increases user data rates in the downlink, in other words for transmission of data from a Node B to the user equipment. HSDPA is an efficient method for delivering relatively large amounts of data in relatively small time periods (the TTI for a HSDPA system is 2 ms). This performance however can only be used when the user equipment is operating within a dedicated channel state (CELL_DCH state), i.e. after a physical layer connection between UE and the RBS has been established and the layer connection has dedicated channels allocated to it.

When the UE is in the process of changing state to the CELL_DCH state, the required state change has to be addressed to the UE by the forward access channel (FACH) which is significantly slower and less robust than the later HSDPA transmission channels.

It is also known to deliver data to a UE not in the dedicated channel (CELL_DCH) state by using the forward access channel (FACH) to deliver small amounts of data or control information to the UE. If the downlink shared channel utilizes a high speed acknowledgement request (HARQ) mechanism, it requires a dedicated uplink feedback link for acknowledging the received data packets and possibly delivering other information about the receiver's situation. So, each user maintains a dedicated connection and delivers uplink acknowledgements for a HARQ re-transmission protocol and channel quality information for helping the scheduler, using the uplink high speed dedicated physical control channel (HS-DPCCH). Accordingly, even though the downlink data are delivered over a shared connection, a dedicated link is used for uplink feedback, e.g. for acknowledging received packets and possibly delivering other information about the receiver's situation (e.g. CQI), and the dedicated link may also be used for delivering power control commands in the downlink to control the transmission power of that feedback channel. In any event, the downlink channel utilising the HARQ mechanism requires a dedicated uplink feedback link. Similar structures and methodologies are currently being defined for the 3GPP Long Term Evolution (LTE or 3.9G).

Release 6 of the Third Generation Partnership Project (3GPP) described various features of a Multimedia Broadcast Multicast Service (MBMS). This MBMS is described in 3GPP TR 25.992, Version 6.0.0 (2003-09), “Multimedia Broadcast/Multicast Service (MBMS); UTRAN/GERAN Requirements,” which is incorporated by reference herein in its entirety.

According to Release 6, the MBMS is specified at the physical layer level in the following way, depending upon the number of users. For point-to-multipoint (p-t-m) transmission, the MBMS uses a Forward Access Transport Channel (FACH) mapped onto a Secondary Common Control Physical Channel (S-CCPCH). For point-to-point (p-t-p) transmission, the MBMS uses a Dedicated Transport Channel (DCH) mapped to a Dedicated Physical Data Channel (DPDCH). Regarding S-CCPCH performance for MBMS, the following document is incorporated by reference herein, in its entirety: 3GPP TR 25.803, Version 6.0.0 (2005-09), “Technical Specification Group Radio Access Network; S-CCPCH Performance for MBMS (Release 6).”

In Release 6, the MBMS is specified at the Medium Access Layer (MAC) level in the following way, depending upon the number of users. For the point-to-point (p-t-p) transmission scenario, the MBMS uses the Dedicated Control Logical Channel (DCCH) and Dedicated Traffic Logical Channel (DTCH). For the point-to-multipoint (p-t-m) transmission scenario, the MBMS point-to-multipoint (p-t-m) Control Logical Channel (MCCH) and MBMS p-t-m Traffic Logical Channel (MTCH) are used. Related scenarios are described in the following application which is incorporated by reference herein in its entirety: “Apparatus, Method, System and Software Product for a Multicast Service on a High Speed Transport Channel Using Point-To-Point and Point-to-Multipoint Transmission” (U.S. Provisional Application 60/812,381 filed 8 Jun. 2006);

In 3GPP Release 7, there is currently an MBMS enhancement study item. See RP-050746, 3GPP TSG RAN #30, titled “Improvement of the Multimedia Broadcast Multicast Services” (2005), which is incorporated by reference herein in its entirety. Also see R2-061189, 3GPP TSG-RAN WG2 Meeting #53, titled “Further Discussion on Delay Enhancements in Rel7” (2006) which is incorporated by reference herein in its entirety.

Continuous Packet Connection (CPC) research and development is ongoing in 3GPP, and in that context the UL DPCCH gating has been discussed. The benefits of gating include reduced UE power consumption allowing longer operation times, and reduced interference thereby increasing the UL capacity.

The use of HSDPA as a dedicated point-to-point bearer for MBMS transmission is not revolutionary, and can already be done in Release 6. In the MBMS over HSDPA concept, the intention is to provide a multicast service over high speed physical downlink shared channel (HS-PDSCH). This can be achieved by using a “common” UE-identification on the HS-SCCH, thereby enabling multiple UE to listen to the HS-PDSCH transmission. Even though the downlink data is delivered over a shared connection, a dedicated link is used for uplink feedback as well as for delivering power control commands in the downlink, so as to control the transmission power of that feedback channel. The following two related patent applications are incorporated by reference in their entirety: “Apparatus, Method and Software Product Involving Retransmission Strategy for a Multicast Service on a High Speed Transport Channel” (U.S. Provisional Application 60/817,786 filed 30 Jun. 2006); and “Apparatus, Method, System and Software Product Involving a Macrodiversity Arrangement for a Multicast Service on a High Speed Transport Channel” (U.S. Provisional Application 60/818,230 filed 30 Jun. 2006).

If the network uses a shared channel (e.g. HSDPA in WCDMA systems) to deliver multicast data to several users, separate uplink feedback (ACK/NACK, CQI) from different users would be required to have a deterministic HARQ behavior and/or link adaptation (CQI). The use of a shared HSDPA channel is discussed in the following document which is incorporated by reference in its entirety: 3GPP TSG-RAN2 Meeting #48, Tdoc R2-052023, “Use of a Shared HSDPA Channel for MBMS ptp Transmission” (2005). CQI for HSDPA is discussed in the following document which is incorporated by reference in its entirety: TSG-RAN WG1 #44, R1-060583, “E-UTRA Uplink Control Signaling—Overhead Assessment” (2006).

Different UE's transmitting separate feedback signals may lead to extensive noise. Additionally, unnecessary feedback signaling causes extra power consumption in the UE. Some limited progress in this area has been made. For example, the following document is incorporated by reference herein, in its entirety: “User Equipment and Communications Node for Communicating Data in a Communications System” (European Provisional Application 06014289.0 filed 10 Jul. 2006). However, this general problem has not been addressed for different services provided on HS-PDSCH. The present invention is directed at solving this problem with a new approach that can also be used more generally.

### SUMMARY OF THE INVENTION

The problem described above can be mitigated in the following way. Based on observed signal quality (CQI), and/or accumulated ACK/NACK signals, and thresholds for these observations, the user equipment (UE) autonomously decides whether to transit uplink (UL) feedback or not. For example, in the case of MBMS over HSDPA, a UE that is in a good situation would not need to transmit ACKs (or even rare NACKs), nor would such a UE need to report CQIs.

Thus, according to the present invention, thresholds are signaled to the UE. The UE then determines the need for UL feedback based on these thresholds.

In the case of CQI, the threshold could be set in terms of a certain CQI level, above which the CQIs would not need to be reported. A single occurrence (or a certain number of occurrences) below the given threshold within a certain (predefined/signaled) window could trigger the need to report the CQI as UL feedback. Thus, the UE would only be required to provide information about channel quality if the UE determines that the channel quality may be getting too low.

In case of ACK/NACK signaling, a signaled parameter could be a threshold number of NACKs (indicating need for re-transmissions) or a ratio of ACKs/NACKs observed over some predefined window. Thus, again, if the UE observes the desired quality target is exceeded (using the threshold number that has been signaled to the UE), then the UE could indicate to the NodeB that additional re-transmissions would be needed. Note that the maximum/fixed number of re-transmission could be either separately signaled, or more feasibly could be included in the signaled parameters.

A combination of both or either of these two approaches (i.e. exceeding a CQI threshold or exceeding an ACK/NACK threshold) could be used to trigger the start of the feedback signaling. Once the observed quality has improved or the quality is restored (e.g. the need for additional re-transmissions has ceased), then the UL feedback signaling can be stopped and/or based on a predefined timer.

### BRIEF DESCRIPTION OF THE DRAWINGS

FIG. 1 shows a system according to an embodiment of the present invention.

FIG. 2 is a flow chart according to an embodiment of the present invention.

FIG. 3 is a block diagram of a mobile device according to an embodiment of the present invention.

### DETAILED DESCRIPTION OF THE INVENTION

A preferred embodiment of the present invention will now be described, merely to illustrate one way of implementing the invention, and without limiting the scope or coverage of what is described elsewhere in this application. According to this embodiment of the invention, additional control software would need to be implemented in the UE, for determining the instances when transmission of UL feedback (FB) signalling is required. And, parameters would need to be signalled to the UE from the network in order to control this feature, and provide service-dependent behavior. Furthermore, NodeB detector would need to be able work on the basis of a discontinuous feedback signal.

This embodiment of the invention removes unnecessary UL transmissions, especially in case of multicast/broadcast packet connections. It also enables more efficient operation in terms of UE power consumption, e.g. for multicast services provided over packet connection access. Thus, this embodiment of the invention has high relevance to mobile TV (broadcast and multicast) in 3G evolution, and will help complement other digital mobile TV standards.

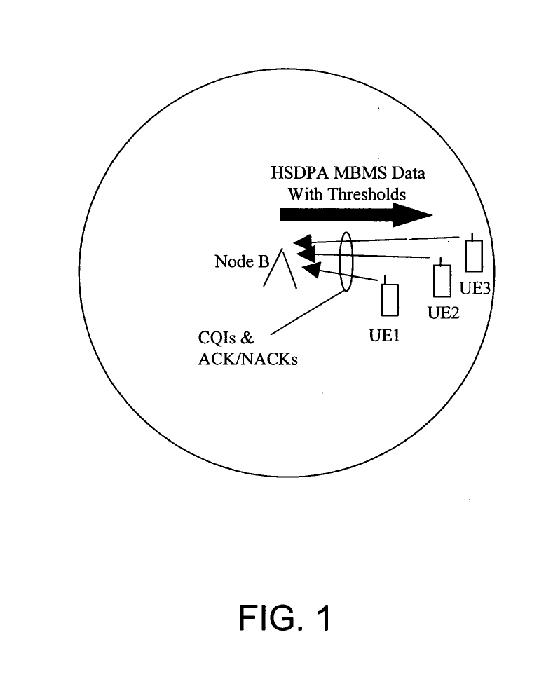

Turning now to the figures, FIG. 1 shows a Node B transmitting MBMS data as well as thresholds to various user equipments. The user equipments then us the thresholds to determine whether to provide feedback about the MBMS data, and the feedback includes things like CQIs and ACK/NACKs.

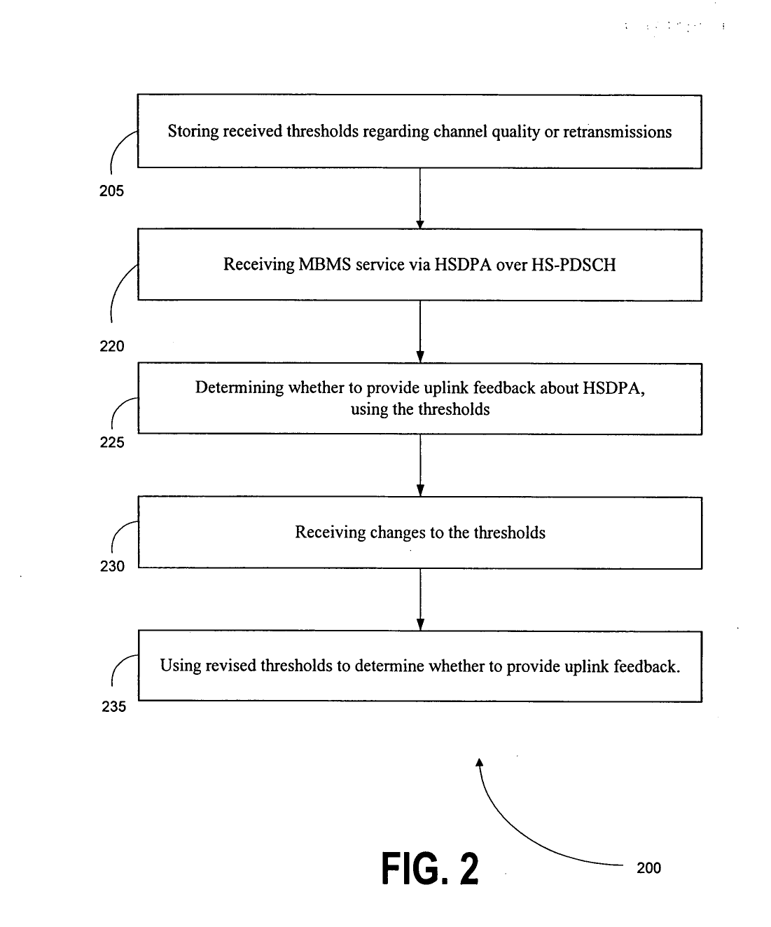

FIG. 2 is a flow chart illustrating a method 200 according to an embodiment of the present invention. Received thresholds are stored 205. An MBMS service is received 220. Then it is determined 225 whether to provide uplink data about the HSDPA (i.e. about reception of the MBMS), using the thresholds to make that determination. Subsequently, the thresholds are changed by a decision at the network side, and those changes are received 230. The revised thresholds are then used 235 to determine whether to provide uplink feedback about the HSDPA.

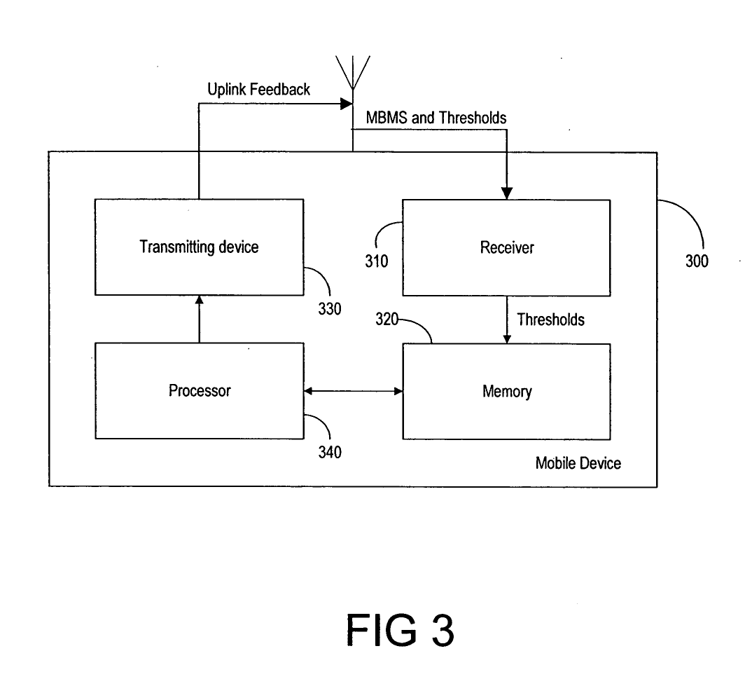

FIG. 3 is a block diagram of a mobile device 300 according to an embodiment of the present invention. A receiver 310 receives both MBMS data along with thresholds. The thresholds are stored in a memory 320. A processor 340 then uses the thresholds to determine whether CQIs or ACK/NACKS are such that uplink feedback should be provided. If so, then transmitting device 330 transmits the uplink feedback.

The embodiment described above can be implemented using a general purpose or specific-use computer system, with standard operating system software conforming to the method described herein. The software is designed to drive the operation of the particular hardware of the system, and will be compatible with other system components and I/O controllers. The computer system of this embodiment includes the CPU processor 340, comprising a single processing unit, multiple processing units capable of parallel operation, or the CPU can be distributed across one or more processing units in one or more locations, e.g., on a client and server. Memory 320 may comprise any known type of data storage and/or transmission media, including magnetic media, optical media, random access memory (RAM), read-only memory (ROM), a data cache, a data object, etc. Moreover, similar to the CPU, the memory may reside at a single physical location, comprising one or more types of data storage, or be distributed across a plurality of physical systems in various forms.

It is noted that the above-described MBMS is merely exemplary. The present invention could instead be applied for HS-FACH (in Release-8 where possibility of uplink is introduced). Thus, the signal via the high speed channel can include a multimedia broadcast multicast service via high speed downlink packet access over a high speed physical downlink shared channel, or alternatively be applied for HS-FACH.

Several concepts included in the present invention will now be briefly described, without in any way limiting what is claimed.

The invention includes a first concept which is a method comprising: storing a received specification of one or more thresholds regarding when to provide uplink feedback; receiving a multimedia broadcast multicast service via high speed downlink packet access over a high speed physical downlink shared channel; and, determining whether to provide the uplink feedback about the packet access based upon whether channel quality falls below at least one of the thresholds, or based upon whether indications about a need for retransmissions exceed at least one of the thresholds.

The invention includes a second concept which is the first concept, further comprising receiving changes to the specification of the one or more thresholds, and accordingly using at least one revised threshold for determining whether to provide the uplink feedback.

The invention includes a third concept which is the first concept, wherein the uplink feedback is provided based upon at least one default threshold after the specification expires, or before the specification has been received.

The invention includes a fourth concept which is the first concept, wherein the uplink feedback is provided in response to a certain number of occurrences of the channel quality below one of the thresholds.

The invention includes a fifth concept which is the first concept, wherein the uplink feedback is provided in response to a certain number of occurrences of indications of a need for retransmissions above one of the thresholds.

The invention includes a sixth concept which is the first concept, wherein the uplink feedback is provided in response to a certain number of occurrences of a ratio of negative to positive acknowledgments above one of the thresholds.

The invention includes a seventh concept which is the fourth concept, wherein the certain number of the occurrences happen within a certain period of time.

The invention includes a eighth concept which is the fifth concept, wherein the certain number of the occurrences happen within a certain period of time.

The invention includes an ninth concept which is the sixth concept, wherein the certain number of the occurrences happen within a certain period of time.

The invention includes a tenth concept which is the first concept, wherein the uplink feedback is provided only if channel quality reaches one of the thresholds and also the indications about the need for the retransmissions reaches one of the thresholds.

The invention includes an eleventh concept which is the first concept, wherein the uplink feedback stops when the one or more thresholds are no longer reached, or after a certain time has elapsed during which the one or more thresholds have not been reached.

The invention includes a twelfth concept which is a software product comprising a computer readable medium having executable codes embedded therein; the codes, when executed, adapted to carry out the functions of: storing a received specification of one or more thresholds regarding when to provide uplink feedback; receiving a multimedia broadcast multicast service via high speed downlink packet access over a high speed physical downlink shared channel; and, determining whether to provide the uplink feedback about the packet access, based upon whether channel quality falls below at least one of the thresholds, or based upon whether indications about a need for retransmissions exceed at least one of the thresholds.

The invention includes a thirteenth concept which is the twelfth concept, further comprising the functions of: receiving changes to the specification of the one or more thresholds, and accordingly using at least one revised threshold for determining whether to provide the uplink feedback.

The invention includes a fourteenth concept which is the twelfth concept, wherein the uplink feedback is provided based upon at least one default threshold after the specification expires, or before the specification has been received.

The invention includes a fifteenth concept which is the twelfth concept, wherein the uplink feedback is provided in response to a certain number of occurrences of the channel quality below one of the thresholds.

The invention includes a sixteenth concept which is the twelfth concept, wherein the uplink feedback is provided in response to a certain number of occurrences of indications of a need for retransmissions above one of the thresholds.

The invention includes a seventeenth concept which is the twelfth concept, wherein the uplink feedback is provided in response to a certain number of occurrences of a ratio of negative to positive acknowledgments above one of the thresholds.

The invention includes an eighteenth concept which is the twelfth concept, wherein the uplink feedback is provided only if channel quality reaches one of the thresholds and also the indications about the need for the retransmissions reaches one of the thresholds.

The invention includes a nineteenth concept which is the twelfth concept, wherein the uplink feedback stops when the one or more thresholds are no longer reached, or after a certain time has elapsed during which the one or more thresholds have not been reached.

The invention includes a twentieth concept which is an apparatus comprising: means for storing a received specification of one or more thresholds regarding when to provide uplink feedback; means for receiving a multimedia broadcast multicast service via high speed downlink packet access over a high speed physical downlink shared channel; and, means for determining whether to provide the uplink feedback about the packet access based upon whether channel quality falls below at least one of the thresholds, or based upon whether indications about a need for retransmissions exceed at least one of the thresholds.

The invention includes a twenty-first concept which is the twentieth concept, wherein the means for storing the received specification is also for receiving changes to the specification of the one or more thresholds, and wherein the means for determining whether to provide the uplink feedback accordingly uses at least one revised threshold.

The invention includes a twenty-second concept which is the twentieth concept, wherein the apparatus is for providing the uplink feedback based upon at least one default threshold after the specification expires, or before the specification has been received.

The invention includes a twenty-third concept which is the twentieth concept, wherein the apparatus is for providing the uplink feedback in response to a certain number of occurrences of the channel quality below one of the thresholds.

The invention includes a twenty-fourth concept which is the twentieth concept, wherein the apparatus is for providing the uplink feedback in response to a certain number of occurrences of indications of a need for retransmissions above one of the thresholds.

The invention includes a twenty-fifth concept which is the twentieth concept, wherein the apparatus is for providing the uplink feedback in response to a certain number of occurrences of a ratio of negative to positive acknowledgments above one of the thresholds.

The invention includes a twenty-sixth concept which is the twentieth concept, wherein the apparatus is for providing the uplink feedback only if channel quality reaches one of the thresholds, and also the indications about the need for the retransmissions reaches one of the thresholds.

The invention includes a twenty-seventh concept which is the twentieth concept, wherein the apparatus is for stopping the uplink feedback when the one or more thresholds are no longer reached, or after a certain time has elapsed during which the one or more thresholds have not been reached.

The invention includes a twenty-eighth concept which is a mobile device comprising: memory configured to store a received specification of one or more thresholds regarding when to provide uplink feedback; receiver configured to receive a multimedia broadcast multicast service via high speed downlink packet access over a high speed physical downlink shared channel; and, processor configured to determine whether to provide the uplink feedback about the packet access based upon whether channel quality falls below at least one of the thresholds, or based upon whether indications about a need for retransmissions exceed at least one of the thresholds.

The invention includes a twenty-ninth concept which is the twenty-eighth concept, wherein the memory is further configured to receive changes to the specification of the one or more thresholds, and wherein the processor accordingly uses at least one revised threshold.

The invention includes a thirtieth concept which is the twenty-eighth concept, wherein the mobile device is configured to provide the uplink feedback based upon at least one default threshold after the specification expires, or before the specification has been received.

The invention includes a thirty-first concept which is the twenty-eighth concept, wherein the mobile device is configured to provide the uplink feedback in response to a certain number of occurrences of the channel quality below one of the thresholds.

The invention includes a thirty-second concept which is the twenty-eighth concept, wherein the mobile device is configured to provide the uplink feedback in response to a certain number of occurrences of indications of a need for retransmissions above one of the thresholds.

The invention includes a thirty-third concept which is the twenty-eighth concept, wherein the mobile device is configured to provide the uplink feedback in response to a certain number of occurrences of a ratio of negative to positive acknowledgments above one of the thresholds.

The invention includes a thirty-fourth concept which is the twenty-eighth concept, wherein the mobile device is configured to provide the uplink feedback only if channel quality reaches one of the thresholds, and also the indications about the need for the retransmissions reaches one of the thresholds.

The invention includes a thirty-fifth concept which is the twenty-eighth concept, wherein the mobile device is configured to stop the uplink feedback when the one or more thresholds are no longer reached, or after a certain time has elapsed during which the one or more thresholds have not been reached.

The invention includes a thirty-sixth concept which is a network element comprising: processor configured to provide a specification of one or more thresholds regarding when to provide uplink feedback; transmitter configured to transmit a multimedia broadcast multicast service via high speed downlink packet access over a high speed physical downlink shared channel; and, receiver configured to receive uplink feedback about the packet access based upon whether channel quality falls below at least one of the thresholds, or based upon whether indications about a need for retransmissions exceed at least one of the thresholds.

The invention includes a thirty-seventh concept which is the thirty-sixth concept, wherein the processor is further configured to provide changes to the specification of the one or more thresholds.

It is to be understood that the present figures, and the accompanying narrative discussions of best mode embodiments, do not purport to be completely rigorous treatments of the method, software product, apparatus, mobile device, and network element under consideration. A person skilled in the art will understand that the steps and signals of the present application represent general cause-and-effect relationships that do not exclude intermediate interactions of various types, and will further understand that the various steps and structures described in this application can be implemented by a variety of different sequences and configurations, using various different combinations of hardware and software which need not be further detailed herein.

What is claimed is:

1. A method comprising:
storing a received specification of one or more thresholds regarding when to provide uplink feedback;
receiving a signal via high speed packet access over a high speed channel; and,
determining whether to provide the uplink feedback about the packet access based upon whether quality of the channel falls below at least one of the thresholds, or based upon whether indications about a need for retransmissions exceed at least one of the thresholds.

2. The method of claim 1, further comprising receiving changes to the specification of the one or more thresholds, and accordingly using at least one revised threshold for determining whether to provide the uplink feedback.

3. The method of claim 1, wherein the uplink feedback is provided based upon at least one default threshold after the specification expires, or before the specification has been received.

4. The method of claim 1, wherein the uplink feedback is provided in response to a certain number of occurrences of the channel quality below one of the thresholds.

5. The method of claim 1, wherein the uplink feedback is provided in response to a certain number of occurrences of indications of a need for retransmissions above one of the thresholds.

6. The method of claim 1, wherein the uplink feedback is provided in response to occurrence of a ratio of negative to positive acknowledgments above one of the thresholds.

7. The method of claim 4, wherein the certain number of the occurrences happen within a certain period of time.

8. The method of claim 5, wherein the occurrence happens within a certain period of time.

9. The method of claim 6, wherein the certain number of the occurrences happen within a certain period of time.

10. The method of claim 1, wherein the uplink feedback is provided only if channel quality reaches one of the thresholds and also the indications about the need for the retransmissions reaches one of the thresholds.

11. The method of claim 1, wherein the uplink feedback stops when the one or more thresholds are no longer reached, or after a certain time has elapsed during which the one or more thresholds have not been reached.

12. The method of claim 1, wherein said indications about a need for retransmissions exceed at least one of the thresholds due to failure of a last known retransmission.

13. A software product comprising a computer readable medium having executable codes embedded therein; the codes, when executed, adapted to carry out the functions of:
storing a received specification of one or more thresholds regarding when to provide uplink feedback;
receiving a signal via high speed packet access over a high speed channel; and,
determining whether to provide the uplink feedback about the packet access, based upon whether quality of the channel falls below at least one of the thresholds, or based upon whether indications about a need for retransmissions exceed at least one of the thresholds.

14. The software product of claim 13, further comprising the functions of: receiving changes to the specification of the one or more thresholds, and accordingly using at least one revised threshold for determining whether to provide the uplink feedback.

15. The software product of claim 13, wherein the uplink feedback is provided based upon at least one default threshold after the specification expires, or before the specification has been received.

16. An apparatus comprising:
means for storing a received specification of one or more thresholds regarding when to provide uplink feedback;
means for receiving a signal via high speed packet access over a high speed channel; and,
means for determining whether to provide the uplink feedback about the packet access based upon whether quality of the channel quality falls below at least one of the thresholds, or based upon whether indications about a need for retransmissions exceed at least one of the thresholds.

17. The apparatus of claim 16, wherein the means for storing the received specification is also for receiving changes to the specification of the one or more thresholds, and wherein the means for determining whether to provide the uplink feedback accordingly uses at least one revised threshold.

18. The apparatus of claim 16, wherein the apparatus is for providing the uplink feedback based upon at least one default threshold after the specification expires, or before the specification has been received.

19. The apparatus of claim 17, wherein the apparatus is for providing the uplink feedback in response to a certain number of occurrences of the channel quality below one of the thresholds.

20. A mobile device comprising:
memory configured to store a received specification of one or more thresholds regarding when to provide uplink feedback;
receiver configured to receive a signal via high speed packet access over a high speed channel; and,
processor configured to determine whether to provide the uplink feedback about the packet access based upon whether quality of the channel falls below at least one of the thresholds, or based upon whether indications about a need for retransmissions exceed at least one of the thresholds.

21. The mobile device of claim 20, wherein the memory is further configured to receive changes to the specification of the one or more thresholds, and wherein the processor accordingly uses at least one revised threshold.

22. The mobile device of claim 20, wherein the mobile device is configured to provide the uplink feedback based upon at least one default threshold after the specification expires, or before the specification has been received.

23. The mobile device of claim 20, wherein the mobile device is configured to provide the uplink feedback in response to a certain number of occurrences of the channel quality below one of the thresholds.

24. A network element comprising:
processor configured to provide a specification of one or more thresholds regarding when to provide uplink feedback;
transmitter configured to transmit a signal via high speed packet access over a high speed channel; and,
receiver configured to receive uplink feedback about the packet access based upon whether quality of the channel falls below at least one of the thresholds, or based upon whether indications about a need for retransmissions exceed at least one of the thresholds.

25. The network element of claim 24, wherein the processor is further configured to provide changes to the specification of the one or more thresholds.
